(19) United States
(12) Patent Application Publication
(10) Pub. No.: US 2004/0203882 A1
(43) Pub. Date: Oct. 14, 2004

(54) Location services

(76) Inventors: Jaana Laiho, Veikkola (FI); Outi Keski-Oja, Espoo (FI); Jarko Niemenmaa, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/294,890

(22) Filed: Nov. 15, 2002

(51) Int. Cl. H04Q 7/20

(52) U.S. Cl. 455/456.1; 455/433

(57) ABSTRACT

There is disclosed a mobile communication system including a plurality of cells each associated with a plurality of radio access points, and at least one mobile user connected in one cell via a radio access point, the system further including a network element associated with said plurality of cells for maintaining a neighbour list for location position determination of the mobile user, the network element including: means for generating an initial neighbour list, comprising the identity of those radio access points determined to be neighbouring the radio access point with which the mobile user is connected; means for temporarily including a candidate neighbour in the neighbour list, comprising the identity of a radio access point determined to be a potential neighbour of the radio access point with which the mobile user is connected; means for collecting measurement reports for each neighbour in the neighbour list, including the candidate neighbour; means for comparing the measurement reports for each neighbour; and means for adding the candidate neighbour to the neighbour list if measurement reports for the candidate neighbour determine that the candidate neighbour is a neighbour of the radio access point, and thereby automatically maintaining a location services neighbour list for a mobile user.

### FIELD OF THE INVENTION

The present invention relates to the provision of correct configuration parameters, such as neighbour lists for the purpose of location positioning in a mobile telecommunications network.

### BACKGROUND TO THE INVENTION

Recently, communication networks have widely spread and are used by a continuously increasing number of subscribers. In order to cope with the challenges of providing multiple services with adequate quality for the subscribers with a limited network capacity, communication networks have to be very carefully planned in order the network can be operated smoothly while meeting all requirements of the subscribers.

Mobile telecommunications systems also utilize applications, which are dependent upon the current location of a mobile station (MS) or user equipment (UE) in the network. The network, or external applications connected to the MS or MS through the network, provides services to the MS or MS in dependence upon the current location.

One example of a mobile telecommunications system is GSM. In the radio access part of a GSM-Edge system (GERAN), location services (LCS) provide a means to locate a subscriber and/or valid user equipment. Once the geographical location is determined, the network provides the location application with the geographical information (e.g. latitude and longitude) of the user equipment. The location application utilizing this information may reside within the wireless network (in the user equipment itself or in the network), or it may reside outside the wireless network (external application). Determination of the positioning of a MS may be initiated either by the network or by an external application.

Location services are intended to be used for various commercial applications, such as the provision of services in dependence upon the current MS location. In addition to commercial applications, in the US there is a need to support the e911 emergency system in mobile telecommunication networks. This requires that it must be possible to locate accurately any mobiles making an emergency call. This location positioning can be done using location services (LCS) techniques.

One of the location services technique is known as enhanced observed time difference (E-OTD). The E-OTD calculates the location of a MS based on the time of arrival at the MS of a signal transmitted from a number of neighboring cells. Depending on the relative time delay of the signals received from the neighboring cells, the position of the MS can be determined.

These positioning techniques require an initial configuration to take place in order to launch the service, like defining the neighbouring cells, which can be used in determining the location of the UE. Not all cells in the network are suitable for this purpose. Furthermore once an initial configuration has taken place, it is necessary to evaluate if the neighbouring cells, which can be used for position determining should be updated. Current techniques for both determining an initial list and maintaining such list are manual, process intensive, being an exhaustive task, and are susceptible to errors. The problem with current EOTD configuration is that all network elements (and the NMS database objects) need to be configured manually. Initial configurations are based on predictions, which are always inaccurate owing to the fact that the mobile environment is changing. The planning tool seldom contains the current network configuration. The modelling in planning tool is not complex enough, etc. Therefore, it is beneficial for the system to change the initial configuration settings to new ones, which are concluded based on real network measurements.

It is an object of the present invention to provide an improved technique for the provision of neighbor lists for the purpose of location positioning in a mobile telecommunications network.

### SUMMARY OF THE INVENTION

According to one aspect the present invention provides a method of generating and optimising a neighbour list for location position determination in a mobile communication system, comprising: generating an initial neighbour list; temporarily including a candidate neighbour in the neighbour list; collecting measurement reports related to each neighbour in the list; comparing the measurement statistics for each neighbour in the list; and adding the candidate neighbour to the list if measurement reports for the candidate neighbour are better than those of a neighbour in the list.

The method may further comprise generating a candidate neighbour list, wherein the step of temporarily including a candidate neighbour in the list includes selecting a neighbour from the candidate list. The candidate neighbours may be selected from the candidate neighbour list in rotation. The method may further comprise, responsive to the addition of a candidate neighbour to the list, deleting a neighbour from the list.

The step of collecting measurement reports may comprise determining a time-based parameter for each neighbour, the time-based parameter being indicative of the proximity of the neighbour to the mobile. The time-based parameter may be a geometric time difference. The time-based parameter may be an observed time difference based on the geometric time difference compensated for a time delay in the system.

The step of collecting measurement reports may comprise determining an interference parameter. The step of generating an initial neighbour list may include compiling said list based on network information.

The step of including an initial neighbour list may include determining a time-based parameter for each neighbour in the network-based list, and editing said list in dependence on the time-based parameter. The time-based characteristic may be indicative of the proximity of the neighbour to a mobile station. A neighbour may be removed from the list if the time-based characteristic indicates the proximity of the mobile to be different from that indicated by other neighbours. The time-based characteristic may be a geometric time difference. The geometric time difference may be based on hyperbola constructions. A quality rating may be associated with the geometric time difference. The quality rating may be determined by hyperbola filtering. The network information may be field strength estimation. The network information may include line-of-sight information. The network information may include carrier to interference information. The interference information may be based on predictions or measurements when generating the initial neighbour lists and based on mobile measurements when optimising the neighbour lists.

In a further aspect the present invention provides a network element for maintaining a neighbour list for location position determination in a mobile communication system, including: means for generating an initial neighbour list; means for temporarily including a candidate neighbour in the neighbour list; means for collecting measurement reports for each neighbour in the list; means for comparing the measurement reports for each neighbour in the list; and means for adding the candidate neighbour to the list if measurement reports for the candidate neighbour are better than those of a neighbour in the list.

The network element may further comprise means for generating a candidate neighbour list, wherein the means for temporarily including a candidate neighbour in the list includes selecting a neighbour from the candidate list. The candidate neighbours may be selected from the candidate neighbour list in rotation. The means for deleting a neighbour from the list may be responsive to the means for adding a candidate neighbour to the list.

The means for collecting measurement reports may determine a time-based parameter for each neighbour, the time-based parameter being indicative of the proximity of the neighbour to the mobile. The time-based parameter may be a geometric time difference.

The time-based parameter may be an observed time difference based on the geometric time difference compensated for the time delay in the system. The means for collecting measurement reports may include means for determining an interference parameter.

The means for generating an initial neighbour list may include means for compiling said list based on network information. The means for generating an initial neighbour list may include means for determining a time-based parameter for each neighbour in the network based list, and means for editing said list in dependence on the time-based parameter. The time-based characteristic may be indicative of the proximity of the neighbour to a mobile station.

The network element may include means for removing a neighbour from the list if the time-based characteristic indicates the proximity of the mobile to be different from that indicated by other neighbours. The time-based characteristic may be a geometric time difference. The geometric time difference may be based on hyperbola constructions. A quality rating may be associated with the geometric time difference.

The quality rating may be determined by hyperbola filtering. The network information may be field strength estimation. The network information may include line-of-sight information. The network information may include measured carrier to interference information.

In a further aspect the present invention provides a mobile communication system including a plurality of cells each associated with a plurality of radio access points, and at least one mobile user connected in one cell via a radio access point, the system further including a network element associated with said plurality of cells for maintaining a neighbour list for location position determination of the mobile user, the network element including: means for generating an initial neighbour list, comprising the identity of those radio access points determined to be neighbouring the radio access point with which the mobile user is connected; means for temporarily including a candidate neighbour in the neighbour list, comprising the identity of a radio access point determined to be a potential neighbour of the radio access point with which the mobile user is connected; means for collecting measurement reports for each neighbour in the neighbour list, including the candidate neighbour; means for comparing the measurement reports for each neighbour; and means for adding the candidate neighbour to the neighbour list if measurement reports for the candidate neighbour determine that the candidate neighbour is a neighbour of the radio access point, and thereby automatically maintaining a location services neighbour list for a mobile user.

In the mobile communication system, the network element may further include means for generating a candidate neighbour list, including the identity of all radio access points which are determined to be potential neighbours of radio access point with which the mobile user is connected, the means for temporarily including a candidate neighbour in the neighbour list including means for selecting at least one neighbour from the candidate list in rotation.

In the mobile communication system, the means for collecting measurement reports may determine a time-based parameter for each neighbour, the time-based parameter being indicative of the proximity of the neighbour to the mobile.

The network element is preferably a network management system, but other types of network element are not excluded.

In a further aspect the present invention provides a computer program product including computer program code for performing a method of determining a neighbour list for location position determination in a mobile communication system, comprising: generating an initial neighbour list; temporarily including a candidate neighbour in the neighbour list; collecting measurement reports related to each neighbour in the list; comparing the measurement statistics for each neighbour in the list; and adding the candidate neighbour to the list if measurement reports for the candidate neighbour are better than those of a neighbour in the list.

In a still further aspect the present invention provides a computer program product including computer program code for carrying out a location positioning method in a mobile communication system including a plurality of cells each associated with a plurality of radio access points, and at least one mobile user connected in one cell via a radio access point, the network further including a network element associated with said plurality of cells for maintaining a neighbour list for location position determination of the mobile user, the method including: generating an initial neighbour list, comprising the identity of those radio access points determined to be neighbouring the radio access point with which the mobile user is connected; temporarily including a candidate neighbour in the neighbour list, comprising the identity of a radio access point determined to be a potential neighbour of the radio access point with which the mobile user is connected; collecting measurement reports for each neighbour in the neighbour list, including the candidate neighbour; comparing the measurement reports for each neighbour; and adding the candidate neighbour to the neighbour list if measurement reports for the candidate neighbour determine that the candidate neighbour is a neighbour of the radio access point, and thereby automatically maintaining a location services neighbour list for a mobile user.

Thus the invention automates the initial location services neighbour list configuration. Furthermore, to improve accuracy, the LCS neighbour lists are preferably auto-tuned based on radio access network and SMLC statistics.

The invention provides a solution in which a positioning system, E-OTD for example, requires no additional actions from installation personnel, with al further actions occurring automatically. The invention provides a huge advancement in the E-OTD configurations and thus significant savings. The process and methods can be incrementally implemented.

### BRIEF DESCRIPTION OF THE DRAWINGS

The invention is now described by way of reference to particular examples shown in the accompanying drawings, in which:

FIG. 1 illustrates an exemplary network architecture for implementation of the present invention;

FIG. 2 illustrates the principle of an example of location positioning;

FIG. 3 illustrates the configuration of a location services neighbour list in accordance with an embodiment of the present invention;

FIG. 4 illustrates an example of a location services neighbour list; and

FIG. 5 illustrates an example entry of the locations services neighbour list of FIG. 4.

### DESCRIPTION OF PREFERRED EMBODIMENTS

The present invention is described herein with reference to a particular example. The invention is not, however, limited to such an example. In particular, the invention is described with relation to an implementation of location services (LCS) in a GERAN architecture.

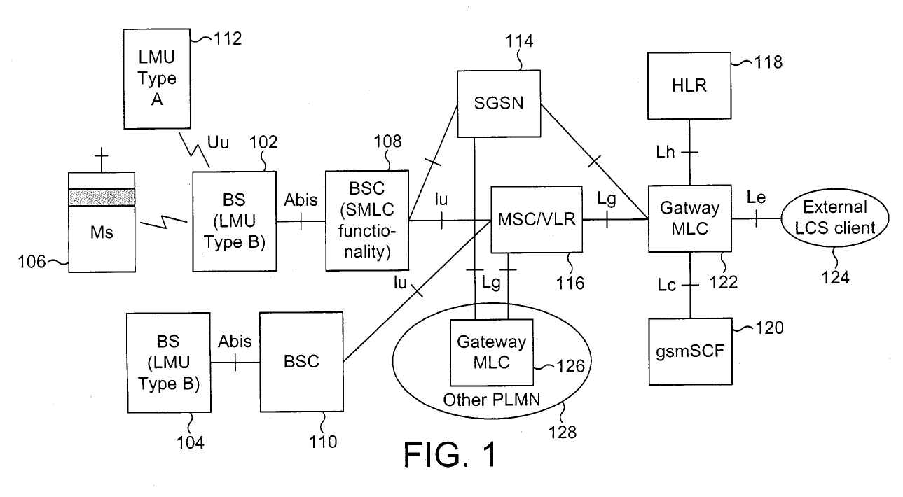

Referring to FIG. 1, there is illustrated the general arrangement of a GERAN LCS architecture for implementing locations services, as defined in 3G TS 25.305. FIG. 1 illustrates, generally, the interconnection of the clients and servers in the core network with the GERAN.

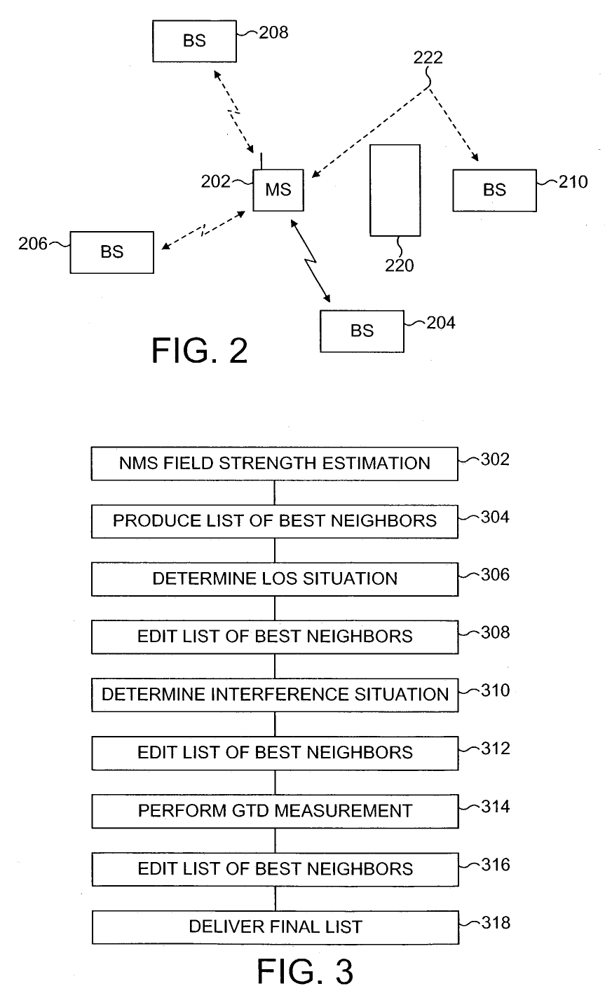

The network architecture includes, as shown in FIG. 1, two base stations (BS), 102 and 104. The base stations represent the access points of the mobile network to mobile stations (MS). In the example of FIG. 2 a single MS 106 is shown, in radio communication with BS 102. BS 102 is connected to a base station controller (BSC) 108 via an Abis interface. BS 104 is connected to a base station controller (BSC) 110 via an Abis interface. The BSC 110 is connected to the MSC/VLR via an Iu interface. The BSC 108 includes the functionality of a serving mobile location centre (SMLC). The BSC 110 accesses the functionality of the SMLC in the BSC 108. The base stations 102 and 104, and the base station controllers 110 and 108 represent the radio access network of the architecture.

Referring to FIG. 1, it can be further seen that each of the base stations 102 and 104 includes a respective location measurement unit (LMU). In addition, the radio access network may include a separate location measurement unit (LMU) 112. In 3G standards, it is proposed to have two alternatives for the implementation of location measurement units. In the first alternative, known as a type A LMU, the LMU is presented as a separate entity and access to its functionality is shared by a number of base stations. This is represented by LMU 112. In the second alternative, a base station is provided within a LMU, as shown in base stations 102 and 104. Where the LMU 112 is provided, then an interface with various base stations is provided. This interface may be on the air interface with a Uu connection, as shown in FIG. 1, or may be a wired interface.

The core network includes a serving GPRS support node (SGSN) 114, a mobile station controller (MSC) 116 including a visiting location register (VLR), a home location register (HLR) 118, a gateway mobile location centre (GMLC) 122, and a serving call function (gsmSCF) 120. The SGSN 114 and the MSC 116 are connected to the BSC 108 via an Iu interface (only 3G interface). The SGSN 114 and the MSC 116 are connected to the GMLC 122 via an Lg interface. The GMLC 122 is connected to the HLR 118 via a Lh interface, and to the gsmSCF 120 via a Lc interface.

The GMLC 122 may be connected to an external location services client, represented by reference numeral 124, via an Le interface. The SGSN 114 and the MSC 116 may be connected to other GMLCs, such as GMLC 126 in a further public land mobile network (PLMN) 128.

The location services system comprises a GMLC, an LMU, and a SMLC. In the example of FIG. 1, the SMLC functionality is provided in the SRNC 108. The LMU functionality may be provided in the individual base stations or in a separate LMU entity 112.

The implementation of the architecture of FIG. 1 and the functionality of location services therein, is outside the scope of the present invention and is well-known to one skilled in the art. However, such architecture provides an exemplary environment for a description of an implementation of the present invention.

The present invention relates to networks in which the locations of MSs is calculated, at least in part, on the basis of a time based technique. An example of such a technique is a so so-called enhanced observed time difference (E-OTD) technique. An embodiment of the invention is now described by way of reference to an E-OTD example. However, the present invention is not limited to such techniques.

Referring to FIG. 2, there is illustrated an example in which a MS 202 is connected to a network via a base station 204. Call sessions are established for the MS 202 through the base station 204. FIG. 2 also shows a number of base stations of neighboring cells, including base stations 206, 208, 210. In the E-OTD technique, signals received at the MS 202 from neighboring base stations are used to determine the location of the MS 202. The present invention, in an embodiment, provides an improvement to the E-OTD technique. As is known in the art, the E-OTD technique acquires measurements from the various base stations in order to determine the location of the MS. Once an initial location is determined, then the location information must be periodically updated. The present invention provides a technique in which the information used to calculate the location of the MS is optimized to allow the technique to be performed more efficiently and furthermore to allow the information to be maintained and updated in an efficient manner.

Referring to FIG. 3, there is illustrated the sequence performed in generating an initial list of base stations for use in calculation of the location of the MS 202. Referring to FIG. 3, in a first step 302 a network management system (NMS) or a radio network planning tool performs a field strength estimation for each cell (i.e. each base station) and its neighbors in order to find the best neighbors for any given MS. The field strength estimation is based on a prediction. It can be further improved by measurements returned to the NMS or a radio network planning tool by other network elements (NEs) from each MS in it's coverage area. It is also possible to utilize measurements collected by a field measurement tool. This measured data is intelligently combined with a prediction in order to calibrate the propagation data.

Once the best neighbors for each MS are determined, they are placed together in a list of best neighbors for that MS, as illustrated in step 304. For the scenario of FIG. 2, the best neighbor list for MS 202 may include base stations 206, 208 and 210, as well as base stations 204.

In a step 306, the line of sight (LOS) situation is analysed for each neighbouring base station, using a prediction tool. The significance of the LOS information can be best understood with reference to FIG. 2. Referring to FIG. 2, it can be seen that there is no direct line of sight between the base station 210 and the MS 202, because some object 220, such as a building, blocks the line of sight. As such although the base station 210 may receive a strong signal from the MS 202, such signal travels to the base station via an indirect path such as path 222. As such the signal received by the base station 210 does not represent a signal travelling on a direct path, and as such the signal information received at the base station does not provide useful information for determining the location of the MS 202. If the information from the base station 210 were used, it would give an erroneous result, as it would indicate that the base station 210 is much further away from the MS 202 than it actually is.

The LOS analysis in step 304 is based on the NMS, or a radio network planning tool, knowledge of the network's physical structure, i.e. the geographical design of the network. If the network's physical structure indicates that for some geographical reason a good enough LOS is not available from a particular base station to a cell where the MS is currently located, given that it is known which cell the MS is in based on its connection to base station 204, then it is determined not to use information from that base station in determining the location of the MS 202. It is known that a clear LOS situation is difficult to achieve in certain propagation environments, thus LOS checking does not always exclude the use of a cell in a neighbouring list. If no LOS analysis is available, the field strength information can be weighted with the normalized distances between the cells and with the difference of the antenna directions relative to 180 degrees. This will amplify the cells with LOS type of propagation and sectors pointing towards the cell in question.

In a step 308, the best neighbour list for each MS is edited as appropriate. In the example of FIG. 2, the list produced in step 304 is edited to remove base station 210, because of the absence of a line of sight.

In a step 310, the NMS estimates the carrier interference (C/I) situation in the network. C/I matrix is based on network measurements. The interference matrix contains information cell pair per cell pair indicating how much (%) interference arises from the interfering cell in question relative to the total interference experienced by the target cell. If the C/I situation in the network indicates that the signal from any particular base station will be strongly interfered, and not generate good results, then it is removed from the list, or a new frequency plan is generated. In a step 312, the NMS generates a further edited list of best neighbours in dependence on the interference situation in the network.

In a step 314, a geometric time difference (GTD) measurement is performed for each cell, i.e. for each base station. In order to obtain the GTD for each base station, the base station, such as base station 204, is provided with the identities of the neighbouring base stations in the list generated in step 312. Thus, the base station 204 is provided with a list including base stations 206 and 208. The base station 204 forwards this list to the MS 202, and the MS returns to the base station 204 measurements for signals received from each of those base stations 204, 206 and 208.

The GTD measurements represent the time delay in a signal received from a base station at the UE. If the network is synchronised, a signal is sent from all base stations 202, 204 and 206 at the same time. The signal from each base station is received at the MS 202 at different time offsets, in dependence on the distance of the respective base station from the UE. The time offsets represent the relative distance of the respective base station from the UE. It is for this reason that only the signals from base stations having a direct line of sight are useful. Based on the GTD for each base stations, a hyperbolic curve can be drawn for each base station. In the example of FIG. 2, and assuming a perfect environment, if the hyperbolic curves for each base station 204, 206 and 208 were drawn, there would be a single point where they would cross, and this point would represent the position of the MS 202.

In practice, the list produced in step 312 includes significantly more than two neighbours, and therefore a plurality of GTD values, and hence hyperbolic curves, are obtained. It is possible that from the hyperbolic curve produced for certain base stations, it can be determined that the result obtained is of very poor quality. This may, for example, be due to an unexpected or temporary line of sight blockage, or poor interference conditions. Any poor quality GTD values can be dropped from the list produced in step 312, and a new list further produced in step 316.

The implementation of the generation of GTD values for each base station is outside the scope of the present invention, but will be understood by one skilled in the art. In practice the network may not be synchronised, and the signals transmitted by each base station to the MS may not be synchronised. In such case, the GTD value for each base station must be offset against a synchronisation difference (RIT) for each base station in order to give the observed time difference (OTD) for each base station.

In addition, an enhanced hyperbola filtering (EHF) step may be carried out to generate an EHF statistic, to provide quality information for each calculated GTD value (hyperbola). The quality of the GTD indicates basically whether the GTD was good or bad. The EHF measurements are done in all cell base stations. For each E-OTD calculation, all calculated GTDs are ranked as good or bad. The information is used in the NMS to define good and bad LCS neighbours.

In practice, rather than performing the individual steps of FIG. 3, and generating an edited list at each stage, the various results obtained in the various steps 302, 306, 310, and 314 may be considered in combination to provide an initial list. A cost function may be formed from these items. In a preferred embodiment, a maximum of 32 good results are selected to be the initial location services (LCS) neighbour list for a given MS. The list is for a given MS, which is connected in the network at any one time through a given base station.

Finally, in a step 318, the final LCS neighbour list for a given BS is delivered to the radio access control (RAC) database, which list is then used in location services for determining the location of the UE. The final list is delivered to relevant network elements.

Once the initial location services neighbour list has been compiled for a given MS, it must be kept updated. Due to changes in the network configuration (new sites added for example) or operating conditions, certain ‘good’ neighbours may become ‘bad’ neighbours and vice versa.

In accordance with a preferred embodiment of the present invention, there is provided an auto-tuning technique for maintaining the location services neighbour list. For auto-tuning the positioning measurement reports are collected in the radio access network. Statistics are gathered indicating how often each LCS neighbour (out of the maximum 32) has been measured, and what has been the average value of those measurement results. In addition any other statistical indicator can be stored, for example the standard deviation of measured signal strengths, for all neighbours, together with any other characteristic of the measurement results. Counters may be provided in the radio access network for monitoring these measurements. These measurements may include interference measurements or GTD measurements for each neighbour.

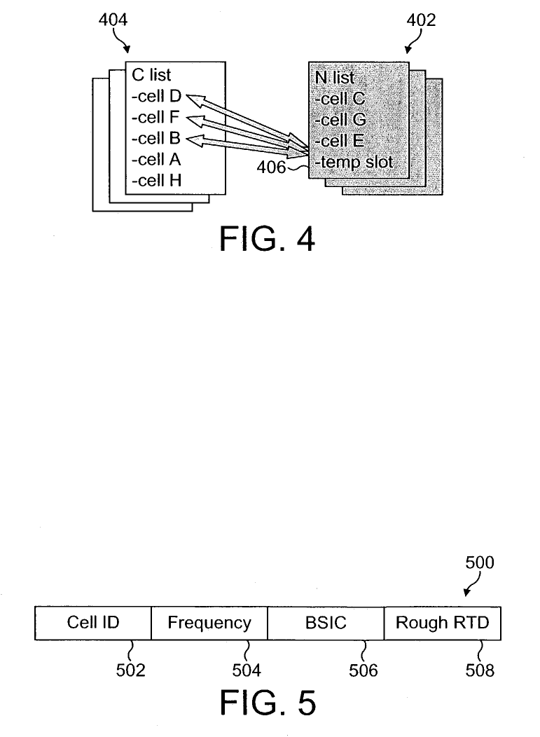

In this described preferred embodiment of the invention, a rotating list is implemented in addition to the location services neighbour list, in order to collect statistics also from those cells not in the initial location services neighbour list. Referring to FIG. 4, a so-called “N list” 402 includes the identity of the maximum 32 neighbours comprising the initial list. In addition, a so-called “C list” 404 includes the identity of those neighbours omitted from the initial location services neighbour list. In order to keep the location services neighbour list as up to date as possible, the location services neighbour list, the N list, is preferably provided with at least one temporary slot, 406, in which a temporary neighbour can be included. This temporary slot is preferably filled with the identity of a neighbour from the C list. Thus, in rotation a neighbour from the C list is included in the temporary slot of the N List. If a neighbour included in the temporary slot returns good results, then it may be maintained in the N list. If a neighbour in the N list returns bad results, then it may be returned to the C list. The C list may initially be compiled of those neighbours dropped in steps 302, 308, 312 and 314 of the initialisation process.

In a particular implementation, if a neighbour included in the temporary slot is used more frequently in the location calculation than the least used cell in the list, then the temporary neighbour replaces that other neighbour in the list and the other neighbour is transferred to the rotating list or dropped completely.

In practice, the best criteria for determining if the measurements returned for a particular neighbour are good is the GTD measurements. The determination as to whether a neighbour should be dropped from the list, or entered onto the list, may be based solely on the GTD values for the neighbour in one preferred embodiment.

The updated list is communicated to the relevant network elements (NEs). The auto-tuning can continue, such that the location services neighbour list is continually dynamically updated.

As described hereinabove, in the described embodiment of the invention the maximum length of the location services neighbour list is 32. However, only 15 neighbour identities can be sent to a MS at any one time, as in the described embodiment this is the maximum number of neighbours the MS can measure results for. Thus, the 15 best neighbours of the 32 neighbours in the location services neighbour list are sent to the MS when positioning measurements are needed.

Simple rules can be generated to pick the best candidates from the full location services neighbor list. The information elements of an example location services neighbor list are shown in FIG. 5. In FIG. 5, it is shown that the information elements of the list may include a cell identifier 502, a BCCH frequency 504, a BSIC (BS identification code) 506, and a rough RTD for the neighbor 508.

The auto-tuning technique in accordance with the present invention preferably also detects changes in the network configuration. A change in the radio access network statistics indicates a change either in the traffic behavior or in the network configuration.

It should be noted that the location services neighbor list is not the same as the neighboring list used for handover purposes. In particular, neighbors having no line of sight with the MS may be included in the handover list, since the signals from the MS may be of good quality despite the lack of a direct line of sight.

The neighbours in the location services neighbour list may, for example, be the cell in which the MS is currently connected, and 2 to 3 tiers of cells around it. The exact definition of this is not, however, essential to the scope of this invention.

The invention has been described herein by way of example with reference to a particular exemplary implementation. The invention is not limited to such an implementation, and one skilled in the art will appreciate that the invention may be more generally application. In particular, the invention is not limited to GERAN applications. For example, the invention may be applicable to UTRAN applications as well.

The invention has been described herein with reference to location positioning techniques based on E-OTD. However, the invention may apply to other techniques measuring timing information (time of arrival e.g. E-OTD, TOA, TDOA and IP/DL OTDOA).

While the invention has been described with reference to a preferred embodiment, the description is illustrative of the invention and is not to be construed as limiting the invention. Various modifications and applications may occur to those skilled in the art without departing from the true spirit and scope of the invention as defined by the appended claims.

1. A method of determining a neighbour list for location position determination in a mobile communication system, comprising: generating an initial neighbour list; temporarily including a candidate neighbour in the neighbour list; collecting measurement reports related to each neighbour in the list; comparing the measurement statistics for each neighbour in the list; and adding the candidate neighbour to the list if measurement reports for the candidate neighbour are better than those of a neighbour in the list.

2. A method according to claim 1, further comprising generating a candidate neighbour list, wherein the step of temporarily including a candidate neighbour in the list includes selecting a neighbour from the candidate list.

3. A method according to claim 2 wherein the candidate neighbours are selected from the candidate neighbour list in rotation.

4. A method according to claim 1 further comprising, responsive to the addition of a candidate neighbour to the list, deleting a neighbour from the list.

5. A method according to claim 1 wherein the step of collecting measurement reports comprises determining a time-based parameter for each neighbour, the time-based parameter being indicative of the proximity of the neighbour to the mobile.

6. A method according to claim 5 wherein the time-based parameter is a geometric time difference.

7. A method according to claim 6, wherein the time based parameter is an observed time difference based on the geometric time difference compensated for a time delay in the system.

8. A method according to claim 1 wherein the step of collecting measurement reports comprises determining an interference parameter.

9. A method according to claim 1 wherein the step of generating an initial neighbour list includes compiling said list based on network information.

10. A method according to claim 9, wherein the step of including an initial neighbour list includes determining a time-based parameter for each neighbour in the network based list, and editing said list in dependence on the time-based parameter.

11. A method according to claim 10 wherein the time-based characteristic is indicative of the proximity of the neighbour to a mobile station.

12. A method according to claim 11 wherein a neighbour is removed from the list if the time-based characteristic indicates the proximity of the mobile to be different from that indicated by other neighbours.

13. A method according to claim 11 wherein the time-based characteristic is a geometric time difference.

14. A method according to claim 13 wherein the geometric time difference is based on hyperbola constructions.

15. A method according to claim 14 wherein a quality rating is associated with the geometric time difference.

16. A method according to claim 15 wherein the quality rating is determined by hyperbola filtering.

17. A method according to claim 9 wherein the network information is a field strength estimation.

18. A method according to claim 9 wherein the network information includes line-of-sight information.

19. A method according to claim 9 wherein the network information includes carrier to interference information.

20. A method according to claim 9 in which an automatic frequency allocation algorithm is utilised, and wherein the network information includes a measured interference matrix.

21. A network element for maintaining a neighbour list for location position determination in a mobile communication system, including: means for generating an initial neighbour list; means for temporarily including a candidate neighbour in the neighbour list; means for collecting measurement reports for each neighbour in the list; means for comparing the measurement reports for each neighbour in the list; and means for adding the candidate neighbour to the list if measurement reports for the candidate neighbour are better than those of a neighbour in the list.

22. A network element according to claim 21, further comprising means for generating a candidate neighbour list, wherein the means for temporarily including a candidate neighbour in the list includes selecting a neighbour from the candidate list.

23. A network element according to claim 22 wherein the candidate neighbours are selected from the candidate neighbour list in rotation.

24. A network element according to claim 21 wherein the means for deleting a neighbour from the list responsive to the means for adding a candidate neighbour to the list.

25. A network element according to claim 21 wherein the means for collecting measurement reports determines a time-based parameter for each neighbour, the time-based parameter being indicative of the proximity of the neighbour to the mobile.

26. A network element according to claim 25 wherein the time based parameter is a geometric time difference.

27. A network element according to claim 26 wherein the time based parameter is an observed time difference based on the geometric time difference compensated for the time delay in the system.

28. A network element according to claim 21 wherein the means for collecting measurement reports includes means for determining an interference parameter.

29. A network element according to claim 21 wherein the means for generating an initial neighbour list includes means for compiling said list based on network information.

30. A network element according to claim 29, wherein the means for generating an initial neighbour list includes means for determining a time-based parameter for each neighbour in the network based list, and means for editing said list in dependence on the time-based parameter.

31. A network element according to claim 30 wherein the time-based characteristic is indicative of the proximity of the neighbour to a mobile station.

32. A network element according to claim 31 including means for removing a neighbour from the list if the time-based characteristic indicates the proximity of the mobile to be different from that indicated by other neighbours.

33. A network element according to claim 31 wherein the time-based characteristic is a geometric time difference.

34. A network element according to claim 33 wherein the geometric time difference is based on hyperbola constructions.

35. A network element according to claim 34 wherein a quality rating is associated with the geometric time difference.

36. A network element according to claim 35 wherein the quality rating is determined by hyperbola filtering.

37. A network element according to claim 29 wherein the network information is a field strength estimation.

38. A network element according to claim 29 wherein the network information includes line-of-sight information.

39. A network element according to claim 29 wherein the network information includes carrier to interference information.

40. A network element according to claim 29 including means for implementing an automatic frequency allocation algorithm is utilised, and wherein the network information includes a measured interference matrix.

41. A mobile communication system including a plurality of cells each associated with a plurality of radio access points, and at least one mobile user connected in one cell via a radio access point, the system further including a network element associated with said plurality of cells for maintaining a neighbour list for location position determination of the mobile user, the network element including: means for generating an initial neighbour list, comprising the identity of those radio access points determined to be neighbouring the radio access point with which the mobile user is connected; means for temporarily including a candidate neighbour in the neighbour list, comprising the identity of a radio access point determined to be a potential neighbour of the radio access point with which the mobile user is connected; means for collecting measurement reports for each neighbour in the neighbour list, including the candidate neighbour; means for comparing the measurement reports for each neighbour; and means for adding the candidate neighbour to the neighbour list if measurement reports for the candidate neighbour determine that the candidate neighbour is a neighbour of the radio access point, and thereby automatically maintaining a location services neighbour list for a mobile user.

42. A mobile communication system according to claim 41, wherein the network element further includes means for generating a candidate neighbour list, including the identity of all radio access points which are determined to be potential neighbours of radio access point with which the mobile user is connected, the means for temporarily including a candidate neighbour in the neighbour list including means for selecting at least one neighbour from the candidate list in rotation.

43. A mobile communication system according to claim 21 wherein the means for collecting measurement reports determines a time-based parameter for each neighbour, the time-based parameter being indicative of the proximity of the neighbour to the mobile.

44. A mobile communication system according to claim 41 wherein the network element includes a network management system.

45. A computer program product including computer program code for performing a method of determining a neighbour list for location position determination in a mobile communication system, comprising: generating an initial neighbour list; temporarily including a candidate neighbour in the neighbour list; collecting measurement reports related to each neighbour in the list; comparing the measurement statistics for each neighbour in the list; and adding the candidate neighbour to the list if measurement reports for the candidate neighbour are better than those of a neighbour in the list.

46. A computer program product including computer program code for carrying out a location positioning method in a mobile communication system including a plurality of cells each associated with a plurality of radio access points, and at least one mobile user connected in one cell via a radio access point, the network further including a network element associated with said plurality of cells for maintaining a neighbour list for location position determination of the mobile user, the method including: generating an initial neighbour list, comprising the identity of those radio access points determined to be neighbouring the radio access point with which the mobile user is connected; temporarily including a candidate neighbour in the neighbour list, comprising the identity of a radio access point determined to be a potential neighbour of the radio access point with which the mobile user is connected; collecting measurement reports for each neighbour in the neighbour list, including the candidate neighbour; comparing the measurement reports for each neighbour; and adding the candidate neighbour to the neighbour list if measurement reports for the candidate neighbour determine that the candidate neighbour is a neighbour of the radio access point, and thereby automatically maintaining a location services neighbour list for a mobile user.
